(19) United States
(12) Patent Application Publication
(10) Pub. No.: US 2011/0318954 A1
(43) Pub. Date: Dec. 29, 2011

(54) SOCKET STRUCTURE OF MINIATURE LIGHT BULB SET

(76) Inventor: De-Hui LIN, Zhubei City (TW)

(21) Appl. No.: 12/823,111

(22) Filed: Jun. 24, 2010

(51) Int. Cl. H01R 13/62

(52) U.S. Cl. 439/366

(57) ABSTRACT

A socket assembly is provided for a miniature light bulb set, including a socket body, a base member that receives power cords set thereon, and a holder that receives and holds a light bulb. The socket body has a bottom portion having front and rear sides forming cord cavities each of which forms a rim to form the structure for positioning and retaining the cord. The base member has left and right sidewalls each forming a retention block that projects outwards and has an increased thickness of material for forming the structure for coupling with the socket body.

### (a) TECHNICAL FIELD OF THE INVENTION

The present invention generally relates to a socket structure for a miniature light bulb set, wherein the socket is improved in respect of a power cord retention structure formed on a bottom of a body of the socket and also an improvement made on a base in respect of a structure for coupling with the socket body.

### (b) DESCRIPTION OF THE PRIOR ART

The miniature light bulb set to which the improvement is made according to the idea of the present invention is of the type shown in U.S. Pat. No. 6,079,848, which discloses a lamp unit of a light bulb comprising a socket that receives a holder that holds a light bulb therein and a base that carries a power cord thereon. The cord comprises three wires that are arranged in parallel to each other. The base comprises a cord retention structure that is formed of a post located at a central portion of the base. The power cord forms a cutout at a central portion thereof. When the power cord is set on the base, the post of the base is fit into the cutout of the power cord to thereby position and retain the power cord. The base is also provided with two fingers on opposite sides thereof and the socket is provided with receiving slots respectively defined in inside surfaces of two side walls thereof, whereby when the socket is coupled to the base, the fingers are fit into the receiving slots to securely fix the socket to the base. However, due to physical constraints set by the wire width of the power cord, the post is not allowed to have a sufficient size, otherwise the central wire of the power cord might get cut off completely. Owing to such a physical constraint, the post does not show a structural strength sufficient to resist damage caused by stretching of the cord, leading to the loss of the function of cord retention. Further, the fingers that are formed on the base to couple with the socket are set on opposite sides of the base in a non-supported manner, where the material connecting between fingers and the base is thin so that the coupling force provided by the fingers is weak, making it easy for the base to separate when the cord is forcibly pulled or stretched. Apparently, the structure of the socket disclosed in the patent is of structural insufficiencies in respect of the cord retention structure of the socket and the structure of the base coupling with the socket. Further improvement is thus desired.

### SUMMARY OF THE INVENTION

In view of the problems discussed previously in association with the known miniature light bulb set, the present invention aims to provide a light bulb socket that comprises a structure for securely retaining power cords and a structure for coupling between the socket and a base member. According to the present invention, a socket assembly is provided, comprising a socket body, a base member that receives power cords set thereon, and a holder that receives and holds a light bulb. The improvements made according to the present invention are that the socket body has a bottom portion having front and rear sides forming cord cavities each of which forms a rim to form the structure for positioning and retaining the cord and that the base member has left and right sidewalls each forming a retention block that projects outwards and has an increased thickness of material for forming the structure for coupling with the socket body. As such, the improved structure makes it possible to completely resolve the problems of the conventional miniature bulb socket that the cord retention structure is susceptible to breaking due to stretching of the cord and thus losing the function of cord retention and that the coupling structure between the base and the socket is not structurally strong enough to securely hold the base and the socket together when the power cord is forcibly pulled.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a light bulb set to which the present invention is embodied.

FIG. 2 is a perspective view of the light bulb set according to the present invention.

FIG. 3 is a cross-sectional view of the light bulb set according to the present invention.

FIG. 4 is another cross-sectional view of the light bulb set according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

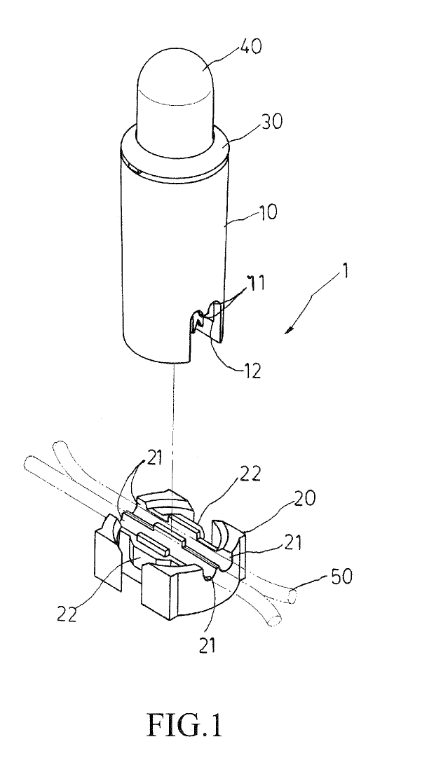

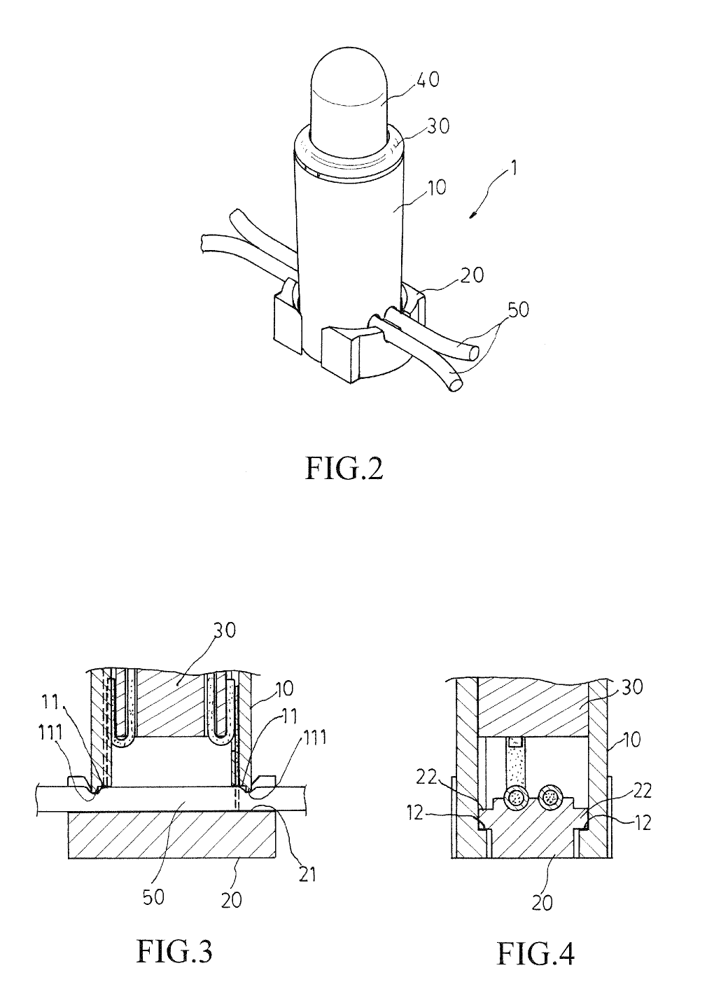

Referring to FIGS. 1 and 2, a light bulb set according to the present invention comprises a socket assembly (1), which comprises a socket body (10), a base member (20) that receives a power cords (5) set thereon, and a holder (30) that receives and holds a bulb (40). As shown in FIGS. 1 and 3, the socket body (10) has a bottom that has front and rear sides in which cord cavities (11) are formed. Each cord cavity (11) forms a rim (111) extending along a sidewall of the cavity (11). As shown in FIGS. 1 and 4, the base member (20) has left and right side walls each forming a retention block (22) that projects outwards and shows an increased thickness of material. The socket body (10) has a bottom portion that has left and right sidewalls each having an inside surface forming a locking channel (12), whereby when there is an attempt to couple the socket body (10) and the base member (20) together, the power cords (50) are first and respectively positioned in cord slots (21) defined in a top of the base member (20) and then the socket body (10) and the base member (20) are brought into engagement with each other in such a way that the retention blocks (22) of the base member (20) are respectively set into the locking channels (12) that are defined in the bottom portion of the socket body (10) to for secured locking engagement therebetween, so as to securely fix the socket body (10) and the base member (20) together without any potential risk of undesired separation. The rims (111) of the cord cavities (11) of the socket body (10) form tight hold-down engagement with the power cords (50) so that the power cords (50) can be securely retained without any cutout formed in the power cord and undesired shifting of the cords are prevented. As such, the improved structure of socket makes it possible to completely resolve the problems of the conventional miniature bulb socket that the cord retention structure is susceptible to breaking due to stretching of the cord and thus losing the function of cord retention and that the coupling structure between the base and the socket is not structurally strong enough to securely hold the base and the socket together when the power cord is forcibly pulled.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A socket structure for use with a light bulb set comprising a socket body, a base member that is adapted to receive power cords set thereon, and a holder that receives and holds a light bulb, wherein the socket body has a bottom portion having front and rear sides forming cord cavities each of which forms a rim to form an arrangement for positioning the cord.

2. The socket structure according to claim 1, wherein the base member has left and right sidewalls each forming a retention block that projects outwards and has an increased thickness of material, the bottom portion of the socket body having left and right sidewalls each having an inside surface forming a locking channel for selective engagement with the retention block to form a coupling arrangement between the base member and the socket body.
